(19) United States
(12) Patent Application Publication
(10) Pub. No.: US 2017/0109347 A1
(43) Pub. Date: Apr. 20, 2017

(54) SOFT SCHEMAS FOR FLEXIBLE INTER-SYSTEM DATA MODELLING

(71) Applicant: AIRBUS OPERATIONS LIMITED, Bristol (GB)

(72) Inventors: Kayvon BARAD, Bristol (GB); Anand PAVASKAR, Bristol (GB)

(21) Appl. No.: 15/293,438

(22) Filed: Oct. 14, 2016

(30) Foreign Application Priority Data
Oct. 15, 2015 (GB) 1518235.5

(51) Int. Cl. G06F 17/30

(52) U.S. Cl. CPC G06F 17/3007; G06F 17/30126

(57) ABSTRACT

A computer implemented method of defining a data model or schema, and subsequently reading files with said defined data model, the method including: identifying a minimum set of elements required to define the data model; defining the data model having a plurality of elements based on the identified minimum set of elements; for a first data source, or file, having a plurality of elements, and for each of the plurality of elements of the data model determining whether the element of the data model is present in the first data source, or file; and in the event that each element in the data model is identified as being present in the first data source or file, generating an output indicative of the first data source or file conforming to the determined data model.

### RELATED APPLICATION

Priority is claimed to Great Britain patent application GB 1518235.5, filed Oct. 15, 2015, the entirety of which is incorporated by reference.

### TECHNICAL FIELD

The present invention relates to system and method for defining a flexible schema for defining a data file format.

### BACKGROUND TO THE INVENTION

For a data file to be machine readable there is a requirement for the machine to know how to read the file. Typically the file will be defined with reference to a data model. The data model defines the data elements and the functional relationship between the elements. When a file is created, the format of the file is defined according to the data model thus ensuring a level of consistency across all files of the particular format. When reading the file, this consistency helps ensure reliability during the reading and recovery of the file.

Accordingly, in order to read a file the machine will check the file in order to determine whether it is compatible, or compliant, with the data model. In order to perform such a check, and to read the file, a formal definition of the data model and its rules are needed i.e. a schema.

The use of such schema and models is known in relational databases, where the structure of the database is described in a formalised language (the schema) and also supports a high degree of flexibility in allowing the reference to be made by name or attribute, and allowing a flexibility in the order of the columns. Similarly in XML, there is defined XSD (XML schema definition) which formally describes the elements in a given XML document. However, in such systems there is the requirement for a “strong” or “rigid” schema and files created using such systems must conform to the defined schema.

It is also known that in order to reuse, part or whole of, a schema that it may be necessary to change the data structure of the software. There are systems known in the art which are based on schema matching, to identify the extent of conformance between two or more schema. Such systems enable the adaption, rebuilding, and creation of, hard schemas in order to utilise data from multiple sources. Such systems are again characterised by the schema having to define all aspects of the data file format. Such a requirement may be onerous and furthermore may prevent the conversion or use of two more data sources if the schemas are found to be incompatible.

### SUMMARY OF THE INVENTION

Accordingly, to overcome at least some of the above problems there is provided: a computer implemented method of defining a data model, or schema, and subsequently reading files with said defined data model, the method comprising the steps of: identifying a minimum number of elements required to define the data model; defining the data model having a plurality of elements and the data model being based on the identified minimum number of elements; for a first data source, or file, having a plurality of elements, for each of the plurality of elements of the data model determining whether the element of the data model is present in the first data source, or file; and in the event that each element in the data model is identified as being present in the first data source generating an output, the output indicative of the first data source or file conforming to the determined data model.

The present invention may be embodied to define a soft or minimum schema in which only a part of the file format is defined. This is in contrast to the prior art where the schema requires the entirety of the file format to be defined. Advantageously the flexible, or soft, schema allows the software to be flexible, or tolerant, to differing inputs aiding in reuse, backward compatibility as well as aiding development even with immature standards.

### BRIEF DESCRIPTION OF DRAWINGS

Other features of the invention will be apparent from the following description of embodiments of the invention, illustrated by way of example only in the accompanying schematic drawings in which:—

FIG. 1 is a flowchart of the methodology of defining and using a soft schema according to an aspect of the invention;

FIG. 2 is an illustrative example of the difference between the soft-schema and the hard schema methodology;

FIG. 3 is an example of a table based implementation of the soft-schema according to an aspect of the invention;

FIG. 4 is an example of tree based schema for a data network found in an aircraft;

FIG. 5a is an illustrative example of a tree based schema for the data network of FIG. 4 and FIG. 5b is an illustrative example of the application of the schema of FIG. 5a to a file;

FIG. 6a is a further illustrative example of a tree based schema for the data network of FIG. 4, FIG. 6b is an example of a file and FIG. 6c an example of the output of a file read according the schema defined in FIG. 6a;

FIGS. 7a and 7b are examples of soft schemas used to identify and define a face;

FIG. 8 is a further example of a soft schema for a face; and

FIG. 9a is a soft schema for an AFDX and FIG. 9b is an illustrative example of learning for the soft schema.

### DESCRIPTION OF AN EMBODIMENT OF THE INVENTION

According to an aspect of the invention, there is provided a new system and methodology for providing a soft schema for data which enables the software to be flexible to differing inputs whilst still maintaining the desired functionality.

An aspect of the invention is that the schema defines the key parts of the data file format to ensure data compatibility and the other parts of the data file format remain undefined or open. This is in contrast to the prior art, where each and every element of the data file format must be defined (even if there is a degree of flexibility in the definition of the schema).

By limiting the schema to only define the minimum number of elements necessary to read the file, the schema may be more easily adopted across different platforms, as well as being more tolerant across different data sources.

Furthermore, by utilising the soft schema a single tool may be used to read data from multiple sources (provided that the data from the sources complies with the soft schema).

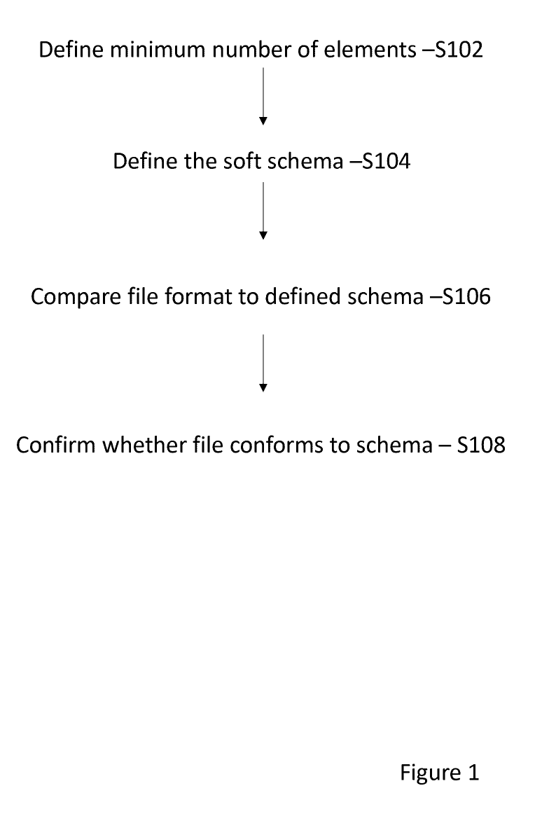

FIG. 1 is a flowchart of the outline of the methodology according to an aspect of the invention.

There is shown the step of identifying the minimum number of elements that are required in order to read the file at step S102.

The minimum number of elements required to identify a file in an embodiment is determined by the context of the file and the subsequent usage of the file. As described in further detail below the same file may be assigned a plurality of different data models depending on the usage and context of the file.

Once the minimum number of elements has been identified, as per step S102, the soft schema is defined at step S104. The definition of the schema, using only the elements identified at step S102, occurs in the known manner.

At step S106 the machine determines whether the format of a file conforms to the schema as defined at step S104, in order to determine if such a file can be read. During the step of checking for each element of the data model/schema, it is determined whether the element as defined in the schema is present in the file being checked. This determination step occurs in the manner known in the art. As stated above, in contrast to the prior art systems, the checking of the file at step S106 only occurs with respect to the minimum number of identified elements, and accordingly the entire file need not necessarily be checked.

At step S108 if the file conforms to the soft-schema the file is read in the known manner. When reading the file according to the defined data schema/model the tool reading the file will need to account for the fact that the entire structure of the file has not been defined. In an embodiment the tool will partially read the data file, and will only read the one or more parts of the file as the file which are defined in the schema. In such embodiments, as the format of the particular elements are known the end user is able to interact, and edit, the content of the file has defined the format of the element being defined.

In further embodiments the tool reading the file will read the file in a known manner and will filter out the elements of the file which are not defined in the data model/schema. Such embodiments are preferred when the user is simply viewing and not interacting/editing the file.

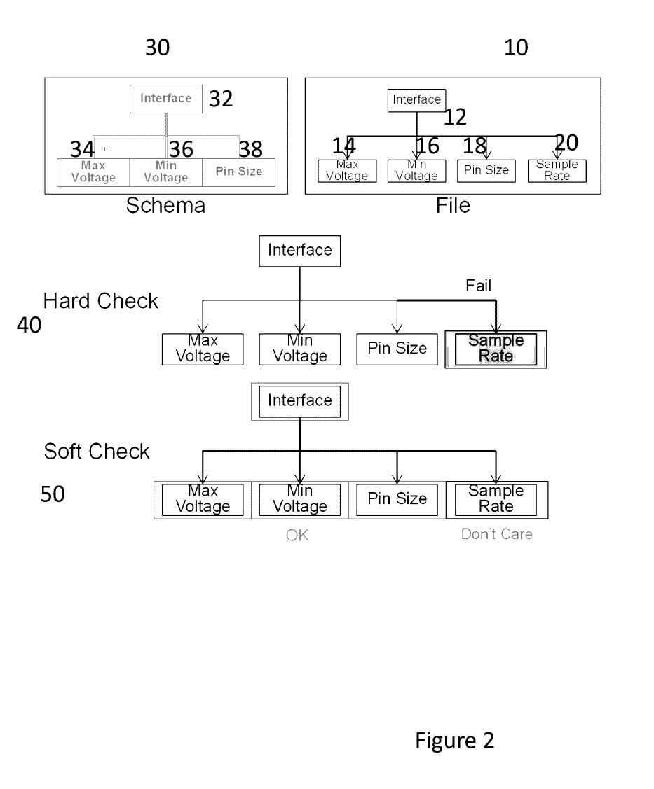

FIG. 2 is an illustrative example of the difference between the soft-schema and the hard schema methodology.

FIG. 2 shows the example of a file used to record data from sensors, for example such as found in an aircraft. There is shown the file 10 comprising five entries: interface 12; max voltage 14; min voltage 16; pin size 18 and sample rate 20.

As per steps S102 and S104 of FIG. 1 the minimum entries required to define the schema in this instance are determined, and illustrated graphically in FIG. 2.

There is also shown the schema 30 for sensors the schema 30 comprising: interface 32; max voltage 34; min voltage 36 and pin size 38.

Accordingly in the example shown in FIG. 2 it has been determined that sample rate 20 is not a required element for sensor data and therefore the definition of the sample rate is not included in the schema 30.

FIG. 2 further shows an illustrative comparison of the file 10 against the defined schema 30 using the “hard” schema check 40, as per the prior art, and the soft, or flexible schema check 50 of the present invention.

In the hard schema check 40 the elements of the file 10 (i.e. interface 12; max voltage 14; min voltage 16; pin size 18 and sample rate 20) are compared with the schema 30. As the file 10 defines the sample rate 20, which is not present in the schema 30 the file is not compatible with the hard schema and therefore deemed not to be compatible.

In contrast the soft schema check 50 will deem the file 10 compatible with the schema 30 as the file 10 has the same minimum requirements as defined in the schema 30. Unlike the hard schema check, in the soft schema check 50 will determine that the file 10 is compatible with the schema 30 as the minimum requirements of the schema have been met.

In summary, provided the file includes the necessary data, the data model is compatible and any extra data not needed is not used. The concepts can be implemented across differing file structures whilst providing the desired flexibility. In particular the flexible schema can be applied to table based and tree based schemas.

For a table based approach: provided there are columns with the correct title any other columns and the order of the columns are ignored. For a tree based approach: any extra nodes are ignored and only part of the structure is needed.

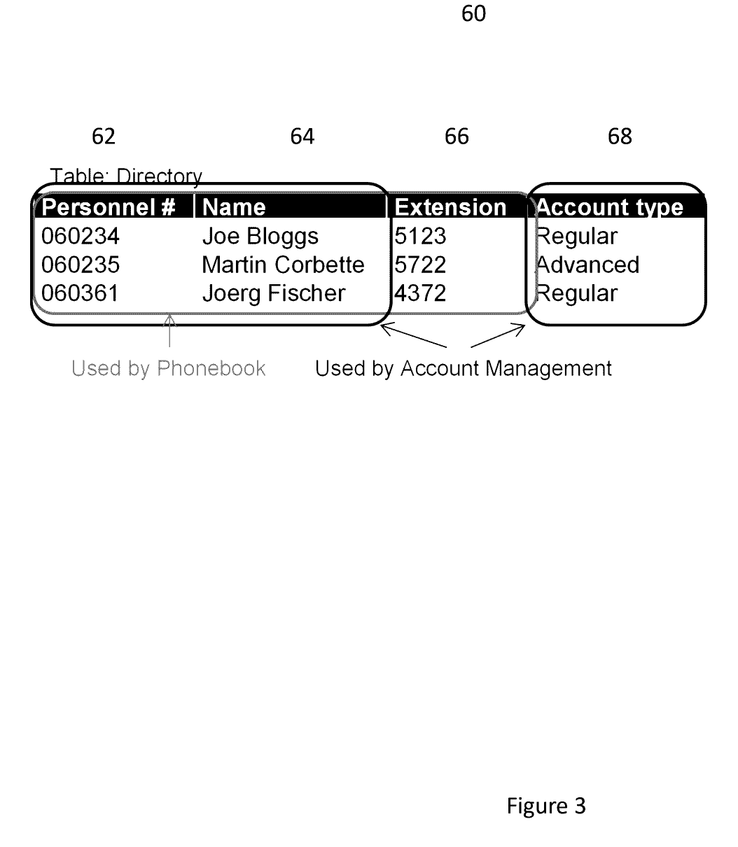

FIG. 3 is an example of a table based implementation of the soft-schema according to an aspect of the invention.

In the example shown in FIG. 3 there is a phonebook database 60, comprising four columns of personnel number 62, name 64, extension 66 and account type 68.

In the example shown the following attributes may be attributed to the respective columns attributes “Personnel #” (type=integer, length=6), “Name” (type=String, 2 words) and “Extension” (type=integer, length=4) and “Account type” (type=enumeration).

Depending on the requirements of program the schema for the program may be defined differently. An aspect of the invention is the ability to differently define the schema, for the same dataset, according to the requirements of the task. In such situations the minimum requirements for each the data element varies according to the task and the soft, or flexible, schema enables the same data set to be defined according to multiple schema. This is in contrast to existing system which require a hard, or rigid, schema in which all elements to be defined, thus preventing multiple schema from being used.

In the example shown in FIG. 3, a first schema is defined for use in a phonebook tool. In such a schema the minimum requirements are identified as “Personnel #” (type=integer, length=6), “Name” (type=String, 2 words) and “Extension” (type=integer, length=4). In such a schema the Attribute account type is not considered to be essential and therefore does not form part of the schema.

Using the same data set a second schema relating to account management may also be defined. In such a schema the tool for account management may only need the attributes “Personnel #” (type=integer, length=6), “Name” (type=String, 2 words) and “Account type” (type=enumeration). With soft schemas it is possible to enforce both schemas to a high integrity, and accept the same database or file for both as shown in FIG. 3.

In further examples additional attributes are added to a file or database which are dedicated to a particular purpose (e.g. V&V fields or simulation data) without impacting any other tools—with their defined schema—which already use the data. This advantage is possible as each tool with a soft schema only checks that the necessary information (as defined by the soft schema) is present, and it is therefore possible to modify the data model of the file or database without breaking compatibility.

Accordingly, the table based schema provides a flexible schema which can be adapted for the tools used to access the data. Furthermore, the same dataset may be accessed by two or more schemas, and subsequently adapted without affecting the ability for the tools to access the data.

As well as table based schema the present invention in further embodiments is used in tree based schema.

The tree based schema embodiments function on the same principles as the table based embodiments. The schema must define a minimum data path for the schema to be met, for example as child nodes, without preventing other elements from existing. The tree based schemas may be more complex than table based schema as the tree based schema allows for nesting and different paths to be defined.

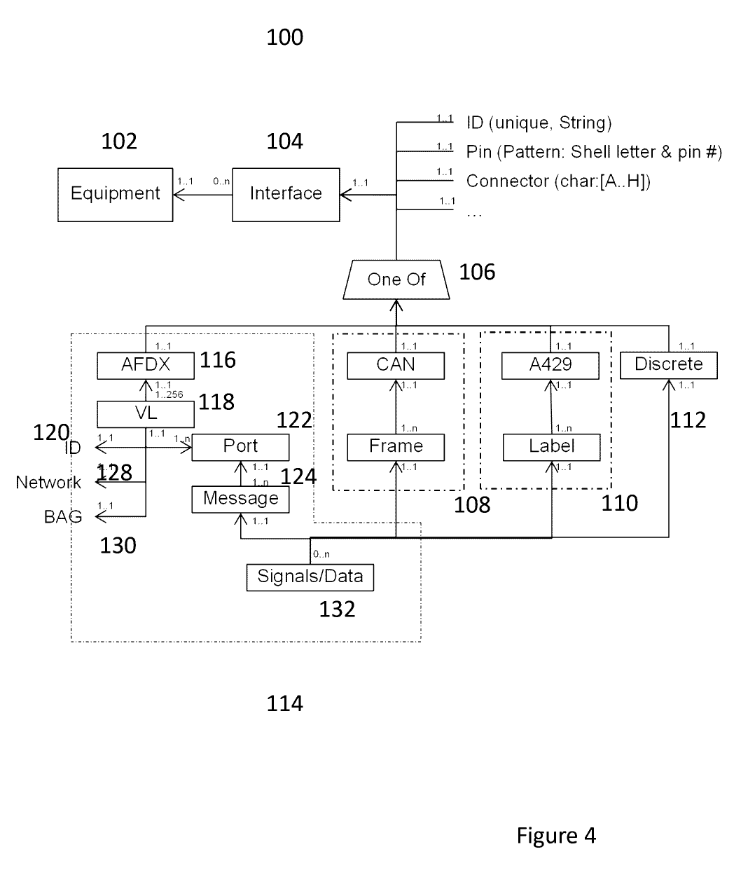

FIG. 4 is an example of tree based schema for a data network found in an aircraft.

There is shown the tree 100 comprising: equipment 102 linked to interface 104. The interface defines a single relationship as one of 106 frame 108; label 110; discrete 112 and the data network 114.

The data network 114 comprises an AFDX 116 (Avionics Full-Duplex Switched Ethernet); VL 118 (virtual links); ID 120; port 122; message 124; network 128; BAG 130 (bandwidth allocation gap) and signals/data 132.

The example shown in FIG. 4 is exemplary and the following concepts may be applied as appropriate to other tree based schema. The example shown in FIG. 4 for reasons of clarity, has single relationships and for ensuring multiple relationships multiple trees are used as required.

A consideration for many commercially available tools is that most tree based libraries work use the path to a node as the reference. For example, using absolute syntax the AFDX port 122 may be referenced as “/Equipment/Interface/AFDX/VL/Port”. However, if a different file uses a model where the AFDX is directly a child of the equipment, or even where the AFDX is directly on the root node then the path to the port changes significantly. Accordingly, allowance must be made in the schema to compensate for such changes in the path in order to help ensure the flexibility of the schema.

To overcome the problems associated with the hard schema and the use of the absolute paths the present invention utilises two different methodologies to define the soft schema for the tree based systems.

The first of the methodologies is a sub tree based approach. As shown in FIG. 4, the data network 114 defines a sub tree of the entire tree 100. Following the methodology outlined in FIG. 1 the minimum elements required to define the schema are identified as per step S102.

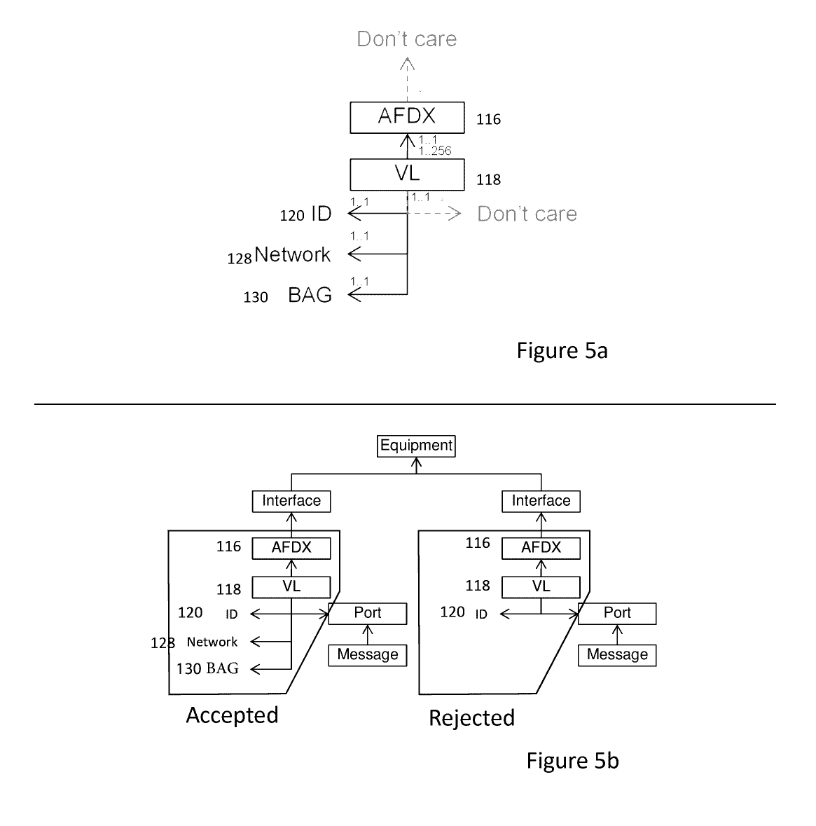

In the following example the minimum elements as identified as per step S102 and resulting schema are shown in FIG. 5a.

The schema shown in FIG. 5a comprises the AFDX 116; VL 118; ID 120; network 128 and BAG 130.

Accordingly the elements such as port 122 have been identified at step S102 as being non-essential in the present example and therefore do not comprise part of the soft schema.

In the sub tree approach the sub tree schema (as illustrated in FIG. 5a) is matched to the data source (as shown in FIG. 5b). In order to overcome the absolute path problems the approach uses a top-down approach where each instance of the topmost, root, node (AFDX 116) is identified. For each instance of the root node the children of the root node are determined and compared to the child node as identified in the schema (here the VL node 118). For each instance of a match of the child node (in the present example the VL node) the child node is subsequently tested for the presence of an ID, Network and BAG as these are identified as the properties of the child node in the schema. If all these items are found, the schema passes, and similarly if one or more of the items is missing the schema fails.

In the present example in XPath terms all attempt to access an ID would have to use “//AFDX/VL/ID” as the tree before the AFDX cannot be predicted, and thus necessitating the top down approach for identifying matches to the soft schema. Tracing from an ID would use relative paths to the parent node to navigate backwards.

As will be appreciated the number of nodes and features of the nodes can be changed according to the requirements of the schema and the tool.

In the tree schema embodiments the schema may be searched and compared using one of several algorithms known in the art used for tree searching. In the example given above, algorithms used for data searching, can be applied here for schema searching. In an embodiment such embodiments would first find the AFDX nodes, then filtering out those which do not have a VL under them, then filtering out those where the VL does not have an ID, Network and BAG under them. In contrast to the hard schemas used in the prior art, only a part of the file has to match the schema and so in a file where there may be files (such as FIG. 5b) where due to missing information some nodes do and some do not match the soft schema.

In some embodiments the tool reading a data file or source may reject the file as there exist AFDX nodes which are not compliant (soft but strict), while other in further embodiments the file is accepted, with only the complete nodes being recognised and incomplete nodes being ignored. In such embodiments preferably the user is presented with a notification on the display to inform the user. (Soft and relaxed)

A second methodology for the tree based schema is a loose tree methodology. This approach provides an increased flexibility and utilises the principle that a first node is an ancestor of another node, but the path and intervening nodes need not be defined.

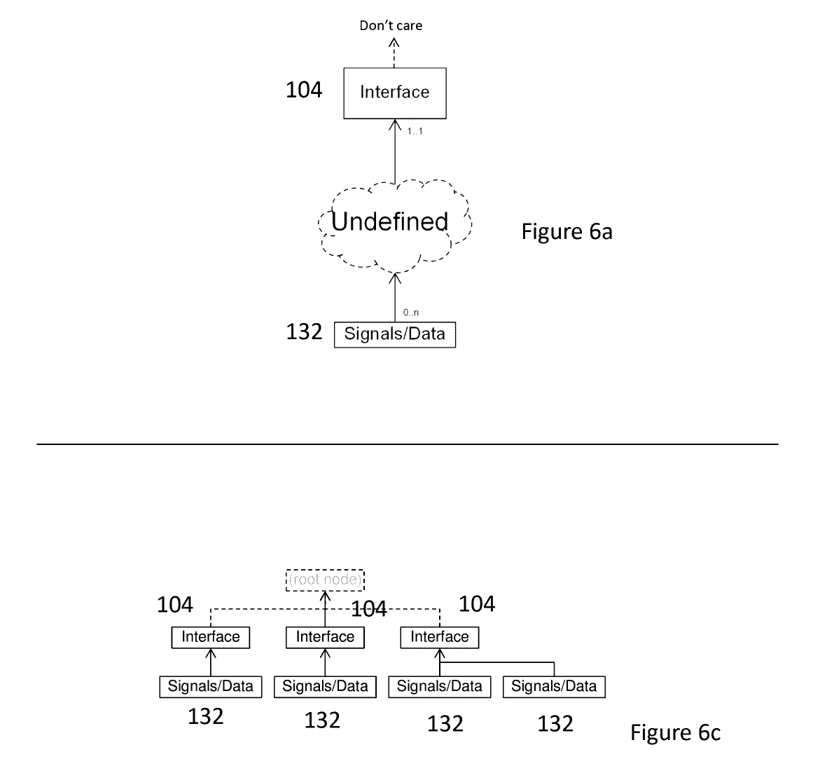

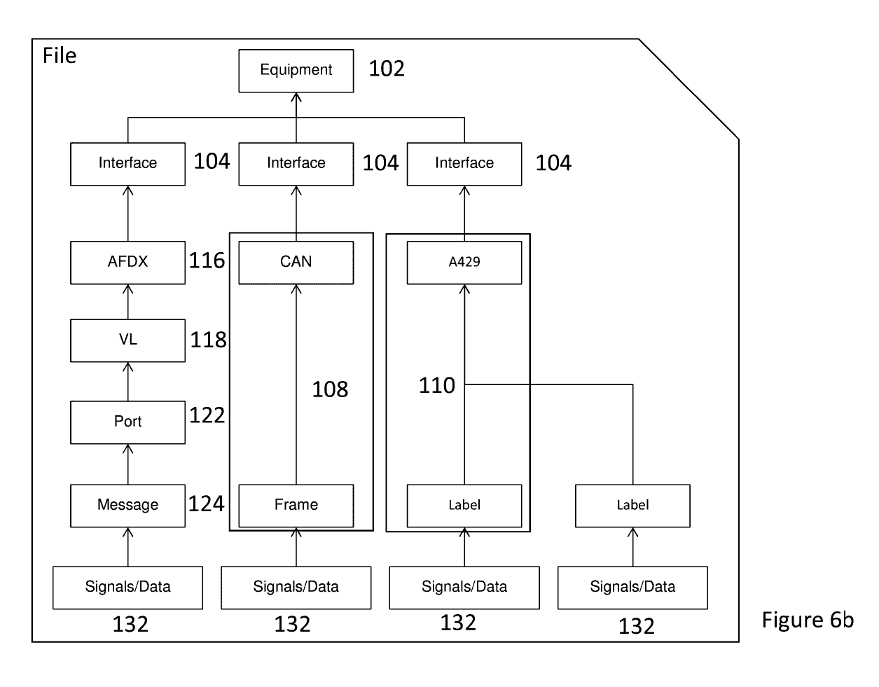

FIG. 6a shows a schematic representation of a loose tree schema for the data shown in FIG. 4. There is shown the interface 104 and signals/data 132 with an undefined link between the two nodes.

In the loose tree schema the root node and one or more descendant nodes are defined. The schema is loose in the sense that the root node may be the parent i.e. direct node of the descendent node(s) or there may be one or more intermediate nodes between the root node and the descendent node which are not defined in the schema. Furthermore one or more of the descendant nodes may have their own descendant nodes. As with the root node there may be none, one or a plurality of intervening nodes which are not defined in the schema. The number of nodes between the root and the descendant node is typically defined as the depth of the node, n. In the loose tree schema, one or more the intervening nodes between the root node and the descendant node are not defined in the schema or data model.

Accordingly, in the loose tree schema, or data model, embodiment the number of elements used to define the data model is less than the depth of the tree.

As commercial of the shelf products (COTS) are unable to define the paths to define the schema in a preferred embodiment the present invention utilises a custom implementation is therefore needed to allow a navigation between the nodes of the loose tree which ignores the presence of intermediate nodes while navigating.

FIG. 6b shows an example file incorporating data model 100 as defined with reference to FIG. 4 and showing the same features.

In the file in FIG. 6b it can be seen that between the Interface and the Signals/Data there is a varying depth depending of which branch of the tree is followed. One parsing algorithm may start at the root of the tree and parse down the tree, identifying any Interface nodes. For each identified node the parsing algorithm subsequently searches the subtree of the node for any signal/data nodes below, regardless of depth. For example for the leftmost subtree there is a depth of five nodes (comprising the AFDX, VL, Port, Message and Signals/Data). As the subtree is identified as having the required schema components a match would be identified. Similarly the middle subtree has a depth of three nodes (CAN, Frame and Signals/Data) and would also be a match as it contains the elements defined in the schema. In further embodiments other parsing algorithms such as starting at the bottom left may be used to get the same result.

As described at step S108 the results of the file are presented to the user. FIG. 6c shows how such a file, parsed through the soft schema in FIG. 6, may be presented to a user.

As described with reference to step S108 in the present example the aspects of the file which are not defined in the schema remain hidden to the user. In further embodiments the tool reading the file will only read the parts of the file defined in the schema.

As can be seen in FIG. 6c only the aspects of the file shown in FIG. 6a are present. For example in the leftmost subtree nodes AFDX, VL, Port and Message are not presented to the user as these nodes were not defined in the schema.

In such an embodiment a user may iterate over the interfaces to cross check parameters of the interface against parameters of the signals/data. Such parameters may be, as an example, comparing the bandwidth of the interface against the sum of bandwidths of the data, or checking that the direction (In/Out/Duplex) of the interface matches the direction of the data. Such checks are considered independent of the intermediate nodes, and using soft schemas may be implemented a single time rather than multiple times or with complex conditional logic to adapt to many types of intermediate tree.

In this embodiment a Root node is defined so that the multitude of Interfaces may be referenced through tree based algorithms which expect to operate on a single tree rather than a cluster of trees. As this soft schema has a “don't care” towards upward nodes this root node is not considered part of the data and is only a facilitating structure.

The use of soft schemas as defined in the present invention make it possible to search or analyse data in a much wider perimeter as it has a much weaker requirement on the structure of the data and only latches onto particular aspects of the data. A key aspect is the flexibility in defining the aspects of the data which are deemed to be important and therefore are used to define the schema. As demonstrated above, the same data may be described by two or more separate schema whereas in a hard schema context the data would only be defined by a single schema which defined each and every element. The flexibility in defining the schema aides in ensuring compatibility and reuse of the software.

A further advantage of the invention, and the loose tree schema in particular, is the ability to find similar patterns and extract information from new but related data models. Such ability to match data therefore enables the greater reuse of software and data, and the ability to define the same product with multiple schema. This loose coupling helps communication between different programs as well as requiring less adaption when reusing a program or data source.

The soft schema therefore results in easier adaption to new data sources (which do not match the schema) as there are less points to comply to fit the schema. Further advantages of the invention include, but are not limited to: cheaper development of software. If soft schema libraries exist then it is much easier to develop software where only the information utilised needs to be specified; cheaper certification and testing. Data model changes no longer require an effort to requalify a tool as there is less overall information in the schema to verify (relying on libraries).

In further embodiments of the invention rather than looking for a perfect match to a hard schema it is possible to look for various related soft schema (which are compatible with the hard schema) and look for matches. The result would be a set of partial matches to the hard schema, with a scored compliance rather than a pass/fail. This type of pattern searching is very close to human pattern recognition and is related to the ability to learn, analyse, or translate existing patterns to new contexts. Soft schema could have a value in Artificial Intelligence, heuristic learning, or optimisation algorithms.

In such embodiments a file is compared to a plurality of schema (in particular as described above a single file may be successfully defined by different soft schema). A score indicative of the match is then assigned to each of the different schema. In an embodiment, if the cumulative score of the different schema passes a threshold then a match is identified. In further embodiments the individual elements which are matched in each schema are identified and a list of all elements identified across all schemas is complied. The list of all identified elements is then analysed to determine whether a match can be made.

When reading a file, in an embodiment, a schema mask, or masking is used to identify and read the elements of the file. The tool reading the file utilises the mask to extract only the elements defined in the schema. In particular masking would allow the tool to extract only the required data elements, without effecting the main schema. Masks in further embodiments can be applied to existing schemas, such as a hard schema, so as to ensure that the main schema remains unaffected.

In further embodiments the soft schema masks are defined by the soft schema and are stored in a database, or associated with the software. The masks are then utilised when required. The masks can be edit in accordance with any changes made to the soft schema and portions of the mask may be added or deleted portions of mask to extend/limit schema boundaries. In further embodiments the masks are adapted in accordance with learning algorithms (see below).

As the masks are utilised to define the minimum data elements they can be applied to the tool reading the file so as to ensure that the tool is only able to read certain elements of the file. Therefore the masks can be used for data protection and security.

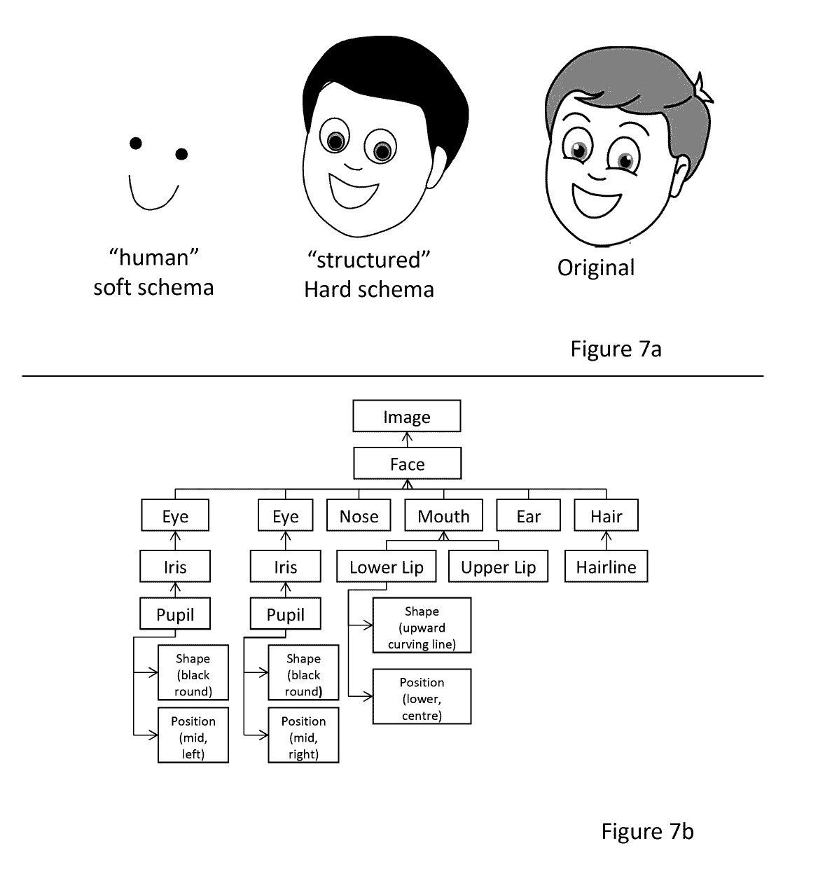

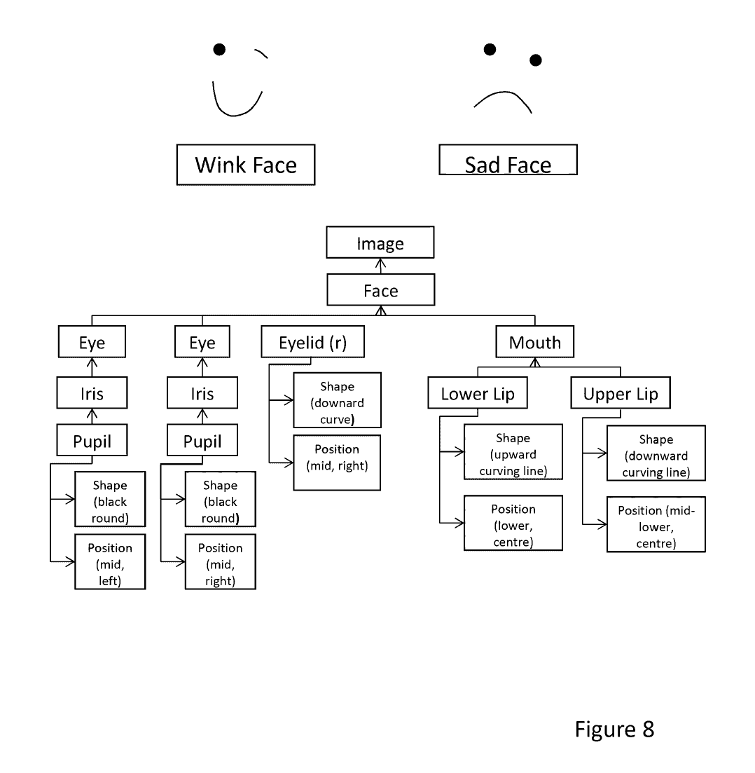

The above embodiment of using a plurality of soft schema to identify a match is described with reference to FIGS. 7 and 8. In FIGS. 7 and 8 the example is given with reference to a simple image recognition schema, and the skilled person would appreciate that the concepts are applicable to file structures, database structures etc.

FIG. 7a shows several stages of a drawing of a face. As shown in FIG. 7a on the left is a minimal set that is almost universally recognised by a human as a smiley face, but in fact only consists of 2 dots and a curve. In the middle is a more structured face, with several nested layers (e.g. eye, iris, pupil). On the right is the original image taken for this example.

FIG. 7b shows a possible schema for a face, with suitable levels of hierarchy and structure and some of the parameters and details that define these elements. As is clear, the leftmost image in FIG. 7a (the basic smiley face) following a hard schema would not be accepted as representing an image of a face as many of the elements of the hard schema are not present.

In FIG. 7b elements represent the minimum nodes that could be considered by a soft schema for recognising a face. In such a schema the elements regarding the shape and position of the eyes and lips are used to define the soft schema the remaining parts of the schema as the undefined elements in the soft schema. The elements which define the soft schema are represented in the shaded boxes, and the unshaded boxes represent the undefined elements of the soft schema. Following this soft schema the face in the left of FIG. 7a would be accepted.

The scored compliance embodiment allows a soft schema or several soft schema to be used where not all elements are always present. In particular such an embodiment is used in order to further refine the schema used to define the data model. By comparing the data model for one or more files to the defined schema, patterns may be observed and used to further refine the schema.

FIG. 8 is an example as to how the soft schema may be updated as a result of comparing the defined soft schema to data models. In FIG. 8 there is shown two faces which are recognisable as a basic face, and a soft schema for describing these faces. In the schema the elements with horizontal hatching are present in the winking face, the elements with vertical hatching are present in the sad face, the elements cross-hatched are present in both, and the unshaded elements are the undefined part of a loose tree. Even though neither image has all the elements, they are both partially compliant to the defined soft schema and also recognisable to humans as being a face.

Each soft schema is then scored for the level of compliance associated with the face. Once a sufficient number of files and levels of compliance have been identified learning patterns may then associate the new observed schema to the soft schema, compare the observed schema to previously observed schemas which match the soft schema and either refine the soft schema or categorise the observed schemas to create new soft schemas which allow the observed patterns to be recognised in future.

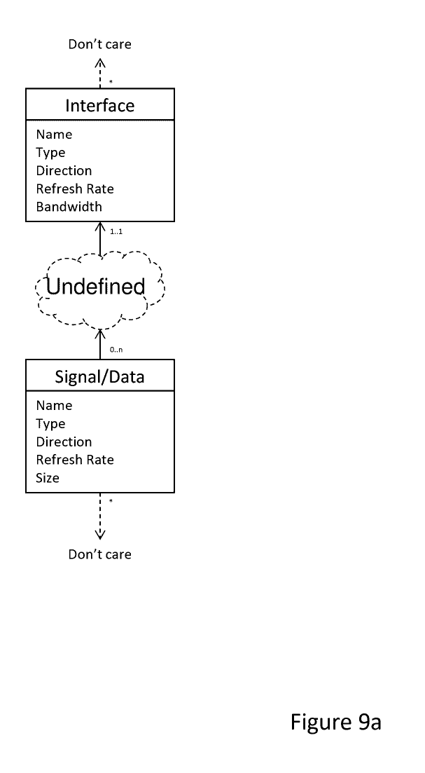

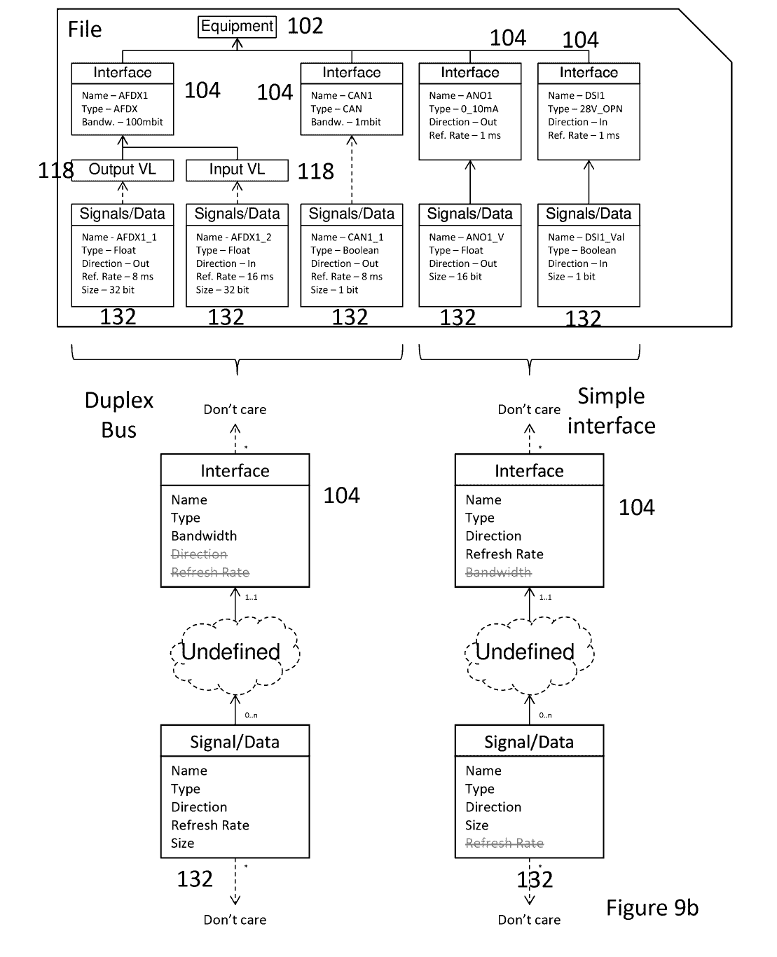

Therefore over time the schema may be updated based on recognised patterns in the data set. FIGS. 9a and 9b provide an illustrative example of the pattern recognition for partially compliant schema. The features are described as per FIG. 4.

FIG. 9a is a further example of a soft schema for aircraft avionic interfaces consisting of an Interface (characterised by Name, Type, Direction, Refresh Rate, and Bandwidth) which may be linked by a loose tree to several signals/data (characterised by Name, Type, Direction, Refresh Rate, and Size). As per the invention the path between the interface and signal/data nodes is undefined as part of a loose tree schema.

As described above where a soft schema is only partially complied to (a match less than 100% but higher than the threshold to identify it as a possible match) it is possible to identify categories within the matching.

FIG. 9b shows an example of a file representative of interfaces found on an aircraft. The file in FIG. 9b is split between a duplex bus and a simple interface. The duplex bus and simple interface both have an interface node and a signals/data node with various properties ascribed to each node. The properties for the individual nodes are shown in FIG. 9b.

As can be seen in FIG. 9b in the duplex bus the interfaces comprise the elements “Name”, “Type” and “Bandwidth”, but not contain elements relating to “direction” and “refresh rate”. The signal/data node of the duplex bus comprise elements Name, Type, Direction, Refresh Rate, and Size. Therefore the duplex bus does not fully comply with the soft schema defined in FIG. 9a.

In the simple interface in FIG. 9b it can be seen that as with the duplex bus the soft schema as defined in FIG. 9a is not fully complied with as the interface node does not define “Bandwidth” and the signal/data node does not define “Refresh rate”.

Over a large enough set of interfaces a pattern is recognisable in the violations, where several Interfaces (AFDX1 and CAN1) violate the soft schema in the same way: missing Direction and Refresh Rate in the Interface. Other nodes (ANO1 and DSI1) violate the soft schema in a different way (missing bandwidth in the Interface and missing refresh rate in the Signals/Data). By using a learning algorithm, the invention is able to find a sufficient correlation between the soft schema and the consistently missing elements. In the event that one or more elements are identified as being consistently missing the soft schema can be amended or a new soft schema defined.

Other learning algorithms or algorithms used for derivation of schemas may also be applied. It can be appreciated that the same technique may also be applied to pattern matching a partially defined pattern (or hypothesis) against an input data set or source where the whole data structure is not fully defined. In this approach the use of soft schema or soft patterns allows a more efficient implementation.

Therefore the use of the soft schemas provides a high degree of flexibility and also allows the schema to be modified in light of the application of the schema to a data set.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

The invention is:

1. A method of defining a data model, and reading files with said defined data model, the method comprising:
identifying a minimum set of elements required to define the data model;
defining the data model having a plurality of elements, based on the identified minimum set of elements;
for a first data source, or file, having a plurality of elements, and for each of the plurality of elements of the data model, determining whether the element of the data model is present in the first data source, or file; and
in the event that each element in the data model is identified as being present in the first data source or file, generating an output, the output indicative of the first data source or file conforming to the determined data model.

2. The method of claim 1, wherein the output is generated even if the first data source comprises at least an element that is not present in the data model.

3. The method of claim 1, further comprising reading the first data source or file according to the data model.

4. The method of claim 3, wherein reading the data source or file according to the data model further comprises presenting the read data source or file on a display.

5. The method of claim 4, wherein only the elements defined in the data model are presented on the display.

6. The method of claim 3, wherein only the elements defined in the data model are read from the first data source or file.

7. The method of claim 1, wherein the data model is table based.

8. The method of claim 7, wherein the table based data model defines one or more columns of the table and at least one attribute for each of said defined columns.

9. The method of claim 1, wherein the data model is tree based.

10. The method of claim 9, wherein the data model defines a root node and a descendent node, and number of elements defined in the data model is less than number of nodes between the root node and the descendent node.

11. The method of claim 10, wherein the data model defines a data path, and one or more intermediate nodes in the data path are not defined.

12. The method of claim 1, further comprising comparing the data model to a second data file.

13. The method of claim 12, wherein the second data file has a plurality of elements, wherein the plurality of elements of the second data file are different from the elements of the data model.

14. The method of claim 1, wherein the minimum set of elements is identified from a data source or file, having a plurality of elements, wherein the minimum set of elements is a subset of the plurality of elements of the data source or file.

15. The method of claim 1, wherein the identification of the minimum set of elements comprises determining from an intended usage or objective of reading the data source or file, and wherein the minimum set of elements is determined based on the minimum information necessary to perform the intended usage or objective.

16. The method of claim 1, further comprising:
for each of a plurality of files, comparing elements of the file with the data model;
identifying and recording each instance of missing an element of the data model in a given file;
identifying one or more patterns in the recorded instances of missing an element of the data model in a given file; and
updating or creating a new data model based on the identified patterns.

17. The method of claim 1, wherein the first data source records data from aircraft sensors.

18. The method of claim 1, wherein the method is implemented on an aircraft.

19. The method of claim 1, wherein the data model is for an aircraft data network or an aircraft avionic interface.

20. A method of parsing data sets or files based on defined data schemas, the method comprising:
identifying a first set of elements as elements of a data schema;
determining whether each element of the data schema is present in a data set or a file to be parsed, the data set or file having a second set of elements, and the second set of elements includes at least one element that is not present in the elements of the data schema; and
in response to the determination that each element in the data schema is present in the data set or file, generating an output indicating that the data set or file conforms to the data schema.

21. The method of claim 20, wherein the data schema is defined based on a table having a plurality of columns corresponding to the first set of elements.

22. The method of claim 20, wherein the data schema is defined based on a tree comprising a plurality of nodes corresponding to the first set of elements.

23. The method of claim 20, wherein the data set or file is parsed based on a plurality of data schemas.

24. The method of claim 20, further comprising:
defining a schema mask based on the data schema, and
using the defined schema mask to identify and read the second set of elements of the data set or file, by extracting elements that are defined in the data schema.

25. The method of claim 20, wherein the schema mask or the schema is modified in accordance with a learning algorithm.

26. The method of claim 20, wherein the data schema or the schema mask is modified based on patterns observed through comparing a plurality of data sets or files to the data schema.

27. A system configured to parse data sets or files based on defined data schemas, the system comprising:
a processing system including a processor, the processing system being configured to:
identify a first set of elements as elements of a data schema;
determine whether each element of the data schema is present in a data set or a file to be parsed, the data set or file having a second set of elements, and the second set of elements includes at least one element that is not present in the elements of the data schema; and
in response to the determination that each element in the data schema is present in the data set or file, generate an output indicating that the data set or file conforms to the data schema.

28. The system of claim 27, wherein the data schema is defined based on a table having a plurality of columns corresponding to the first set of elements.

29. The system of claim 27, wherein the data schema is defined based on a tree comprising a plurality of nodes corresponding to the first set of elements.

30. The system of claim 27, wherein the system is on an aircraft.

31. The system of claim 27, wherein the data set or file includes data from aircraft sensors.
